(19) United States
(12) Patent Application Publication
(10) Pub. No.: US 2003/0021391 A1
(43) Pub. Date: Jan. 30, 2003

(54) Method and apparatus for determining distance qualification and electrical qualification of a telephone line for high speed communications

(76) Inventors: David A. Rubin, Delray Beach, FL (US); Anthony M. Kolodzinski, Massapequa Park, NY (US)

Correspondence Address: Sheldon R. Meyer, FLIESLER DUBB MEYER & LOVEJOY LLP, Four Embarcadero Center, Fourth Floor, San Francisco, CA, 94111-4156, US

(21) Appl. No.: 10/159,795

(22) Filed: May 31, 2002

Related U.S. Application Data
(60) Provisional application No. 60/295,311, filed on Jun. 1, 2001.

(51) Int. Cl. H04M 1/24; H04M 3/22; H04M 3/08

(52) U.S. Cl. 379/22.04; 379/22; 379/1.04; 379/24; 379/27.01; 379/29.01

(57) ABSTRACT

The invention provides a system and method for testing a telephone or communications line to determine if the line qualifies for a particular type or class of communications service, for example DSL service. In accordance with one embodiment, a potential customer can download a software program. The program first performs a DSL distance qualification calculation. If the customer's line passes this step, the program determines whether the line coupled between the customer and a central office servicing that customer is electrically qualified for DSL communications. A series of tests to measure signal levels, noise, and other characteristics are performed by a test server, which generally include local loop tests to determine the presence of bridged taps, load coils, and subscriber line concentrators. After the tests are completed, the customer can receive the results, order completion and other instructions.

### CLAIM OF PRIORITY

This application claims priority from provisional application “METHOD AND APPARATUS FOR DETERMINING DISTANCE QUALIFICATION AND ELECTRICAL QUALIFICATION OF A TELEPHONE LINE FOR HIGH SPEED COMMUNICATIONS”, Application No. 60/295,311, filed Jun. 1, 2001, and which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to the field of digital subscriber line (“DSL”) information systems. More particularly, the present invention relates to determining whether a telephone line coupled between a customer and a telephone company central office is of the necessary distance and has the necessary electrical properties to support high speed communications, such as DSL.

### BACKGROUND

Data networks such as the Internet are becoming increasingly popular for a wide variety of applications, including electronic commerce. Internet customers are constantly searching for World Wide Web (“web”) sites to access, use and transmit a wide variety of information. Many web sites are regularly updated to offer larger files and higher concentrations of files, such as high-resolution image files. Other web sites have the capability of outputting streams of audio and full-motion video signals. Consequently, customers who want to access and use these files and signals are demanding communications technologies which provide the necessary speed and bandwidth to deliver such data.

Many Internet customers prefer to access the Internet from their homes. The demand, not limited to home users, for such access is likely to increase as more and more customers use the Internet at home for various purposes including business, education and entertainment. Thus, the communications lines over which customers access the Internet from their homes have become important links in providing sufficient support for modern applications. The speed and bandwidth at which data is transferred over these communications lines is desirably maximized while minimizing the cost of the lines.

Existing telephone lines are one means of providing Internet access to home customers. As shown in FIG. 1, communications paths may be established over a pair of telephone lines 101, 102 to allow a customer operating out of his home 103 to access the Internet. The customer uses a personal computer (“PC”) 104 coupled to a modem 106 and dials into a central office (“CO”) 108 owned by the telephone company. Through the CO, the customer accesses an Internet service provider (“ISP”), such as ISP 210 of FIG. 2. The use of existing telephone lines to establish these types of communications paths is particularly desirably to minimize cost, because these lines have already been installed by the telephone companies for entire communities of customers throughout the United States.

One problem with using existing telephone lines for modern data communications, however, stems from the fact that these lines are generally made of copper. The use of a metal such as copper imposes constraints on the bandwidth and speed at which data can be transmitted, constraints which are not imposed by other mediums such as optical fiber.

Some customers continue to use conventional modems to communicate over existing telephone lines. Most of these modems receive data at a maximum rate of about 56,000 bits per second and send data at an even lower rate. Such data rates may be sufficient to convey textual information, but are becoming insufficient for sending larger image files and audio and video signals at reasonable transmission rates. Thus, some customers are choosing to use cable modems or digital subscriber lines (“DSL”) as alternative means for delivering data over existing telephone lines.

FIG. 2 illustrates a conventional DSL telecommunications system 200 including a customer's PC 204 and DSL modem 206 in communication with an ISP 210 through a telephone company CO 208. DSL modem 206 communicates with the telephone company CO 208 via a copper telephone line 212. The CO 208 communicates with the ISP over an ISDN or T3 line 214. ISP 210 is coupled to and in communication with the Internet 216. DSL communications between the customer and CO 208 are supported by telecommunications system 200.

DSL technology allows data to be transmitted over existing copper telephone lines at frequencies higher than those used to send ordinary voice signals. In FIG. 2, data is generally transmitted from the telephone company CO 208 to customer's PC 204 at a rate of about 6 to 8 megabits per second. Data is transmitted from the customer's PC 204 to CO 208 at a lower rate, typically about 1 megabit per second.

There are problems associated with DSL, however. Because of the higher signal frequencies at which DSL digital data is transmitted, DSL connections are typically available only for homes within a certain distance of cable from a telephone company CO. DSL manufacturers recommend that lines no longer than 18,000 feet be used between the customer's home and the CO. Telephone companies generally will not install DSL lines longer than 15,000 feet. For telephone lines having poor electrical characteristics, this maximum distance may be even lower.

In geographic regions where DSL is generally available, it can cost hundreds of dollars to send a DSL installer to a potential customer's location. It can then cost hundreds of dollars to install the necessary DSL hardware. Furthermore, such installations are often found to be unsuccessful because the local loop, the telephone line between the customer and the CO, is incapable of supporting DSL communications for various reasons, including the following:

Excessive Cable Length

In FIG. 1, the length (“L”) of the existing telephone lines 101, 102 between customer's house 103 and telephone company CO 108 may exceed the maximum length that supports DSL, theoretically, about 18,000 feet. If this is the case, DSL communications will not be supported over lines 101, 102.

Load Coils

Ordinarily, signal levels decay along a transmission line as the signal propagates along the line. In FIG. 1, load coils 110 and 111 are passive electrical devices that are coupled along telephone lines 101, 102 to prevent the natural attenuation of voice signals along this local loop. A load coil boosts the signal level of the voice signal as the signal passes through the coil. This holds true particularly at higher frequencies of the voice signal, assuming the coil is properly positioned along the telephone line. Load coils, however, are generally incapable of passing DSL signals. Thus, the presence of a load coil on a local loop disqualifies the loop from supporting DSL communications.

Bridged Taps

Bridged taps or stubs, such as tap 112 in FIG. 1, are often coupled along a local loop to provide access to the loop for homes in a community. Bridged taps serve to connect customers along the loop.

Relatively short bridged taps are not a problem for DSL communications. Relatively long bridged taps, however, are problematic. These long bridged taps present various barriers to DSL communications, like reducing the signal levels of signals transmitted along the loop and causing electrical echoes. Depending on the placement of the stub and the other characteristics, the presence of one or more long bridge taps will generally disqualify a local loop from supporting DSL technology.

For example, in one community, a customer's house is approximately 5000 feet from the local CO. While the telephone cable is designed to continue 20,000 feet past that customer's house throughout the community, that customer has a bridged tap 20,000 feet long. This long bridged tap would present such a high impedance to DSL signals to electrically disqualify the local loop from DSL consideration.

Subscriber Line Concentrators/Pair Savers/Digitally Added Multiple Line

Rather than employing multiple pairs of cables which run 10,000 or 20,000 feet through a community, one “high speed” pair of cables can be used. A subscriber line concentrator (“SLC/DLC/DAML”) also know as a Digital Loop Carrier (DLC) Digitally Added Multiple Line (DAML), Pair Saver/Pair Gain Device is a device that interfaces with the high speed cable and provides multiple copper lines, each of these lines coupled to a house in the community. The SLC/DLC essentially aggregates these individual copper lines into the one high speed cable pair or fiber line. Currently, the presence of an SLC/DLC disqualifies a telephone line from supporting DSL communications.

### SUMMARY OF THE INVENTION

The present invention allows a user to quickly and inexpensively conduct an electrical qualification test on a telephone line to determine if the line qualifies for DSL service. According to one exemplary embodiment, the electrical qualification test is conducted. According to another exemplary embodiment, the electrical qualification test is performed in conjunction with a distance qualification test. The present invention streamlines the process of offering DSL service while increasing sales of DSL subscriptions.

Electrical qualification performed in accordance with the present invention provides many benefits, including the following:

Instant Calculation of Local Loop Electrical Characteristics

A potential customer automatically dials into a centralized site and self-initiate the testing of his telephone line. In a few minutes or less, accurate test results are determined and communicated to the customer or the company endeavoring to provide the DSL service.

Access Via the Internet

Potential DSL customers, at their convenience, can easily determine if their line electrically qualifies for DSL service. First, a customized software package is downloaded from an Internet site to the customer's computer after the customer responds to a series of simple questions. When executed, the software package operates in conjunction with various hardware to conduct DSL electrical qualification testing.

Minimization of DSL Installation Expenses

DSL qualifiers constructed according to the present invention minimize installation costs. The system eliminates the costs associated with a telephone company/DSL provider otherwise attempting to determine whether the phone line qualifies for DSL and/or installing DSL hardware only to later discover that DSL communications are not supported. Instead, the customer simply executes the software package described above to perform the qualification process. Overall customer satisfaction is improved.

Promotion of E-Commerce

By providing the DSL qualifier on a particular web site, customers are encouraged to visit the site and discover DSL and other product offerings.

Complete Performance of Qualification Process

Exemplary DSL qualifiers constructed according to the present invention provide both distance and electrical calculations for a local loop. The qualifier automatically detects conditions on the local loop that hinder DSL communications.

In accordance with one embodiment, the invention provides a system for allowing a communications service provider to test the ability of a communications line to support a particular type or class of communications service, comprising: a test server, for providing a connection over a communications line between a user's equipment and the system; a test equipment, coupled with the test server, for performing tests to determine the characteristics of the communications line, wherein the tests include comparing the characteristics of the line being tested with previously collected data describing the characteristics of communications lines having known properties such as distance, conditions or artifacts thereon; and, a reporting device, for reporting the results of the tests.

In accordance with another embodiment, the invention provides a method for testing a user's communications line to assess the ability of the communication line to support a particular type or class of communications service, comprising the steps of: providing a Web page at which a user can retrieve or download a software program to the user's computer system or other equipment; allowing the software program to connect the user's equipment to a test server via the communications line to be tested; testing, using a test equipment, the signal level, noise or other properties of the communications line, wherein said step of testing includes comparing the characteristics of the line being tested with previously collected data describing the characteristics of communications lines having known properties such as distance, conditions, or artifacts thereon; assessing the ability of the line to support the particular type or class of communications service; and, reporting the results of the testing to the user.

### BRIEF DESCRIPTION OF THE DRAWINGS

FIG. 1 illustrates a conventional local telecommunications system 100 including a customer using a PC 104 and modem 106 in communication with a telephone company central office 108;

FIG. 2 illustrates a conventional DSL telecommunications system 200 including a customer using a PC 204 and DSL modem 206 in communication with an ISP 210 through a telephone company central office 208;

FIG. 3 illustrates DSL distance and electrical qualification apparatus 300, constructed according to an exemplary embodiment of the present invention, for determining whether a telephone line qualifies for DSL communications;

FIG. 4 illustrates exemplary data flow 400 for determining distance and electrical qualification of a telephone line for DSL communications, according to an exemplary embodiment of the present invention;

FIG. 5 illustrates an exemplary method 500 for determining distance qualification of a telephone line for DSL communications, according to an exemplary embodiment of the present invention;

FIGS. 6a and 6b illustrate an exemplary method 600 of determining electrical qualification of a telephone line for DSL communications, according to an exemplary embodiment of the present invention;

FIG. 7 illustrates an exemplary status display screen as displayed on a user's PC during the execution of method 600 of determining electrical qualification for DSL communications, according to an exemplary embodiment of the present invention; and

FIG. 8 illustrates an exemplary message as displayed on a user's PC after execution of method 600, when positive test results are obtained, according to an exemplary embodiment of the present invention.

FIGS. 9A and 9B illustrate an exemplary DSL test algorithm in accordance with an embodiment of the invention.

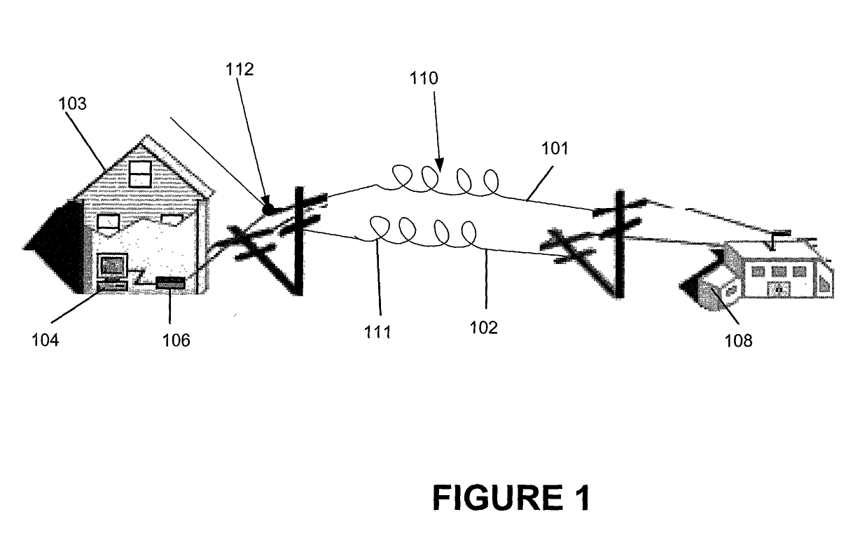

### DETAILED DESCRIPTION

The present invention allows a user to quickly and inexpensively conduct an electrical qualification test on a telephone line to determine if the line qualifies for DSL service. According to one exemplary embodiment, the electrical qualification test is conducted. According to another exemplary embodiment, the electrical qualification test is performed in conjunction with a distance qualification test. The present invention streamlines the process of offering DSL service while increasing sales of DSL subscriptions. Electrical qualification performed in accordance with the present invention provides many benefits, including the following:

Instant Calculation of Local Loop Electrical Characteristics;

Access Via the Internet;

Minimization of DSL Installation Expenses;

Promotion of E-Commerce; and,

Complete Performance of Qualification Process.

Exemplary DSL qualifiers constructed according to the present invention provide both distance and electrical calculations for a local loop. The qualifier automatically detects conditions or artifacts on the local loop that hinder DSL communications. Unlike other methods that merely test the signal level versus frequency curve of the line and then use field installation information to qualify the communications line, the present invention uses a series of tests to determine line qualities such as the electrical distance, and then uses the resulting information from these tests to characterize the line as having any conditions or artifacts, such as BT's LC's DLC's etc. The line information is then used to determine whether it qualifies for the particular type of service. To do this successfully, the invention uses a reference set of empirical or laboratory data, created by previously performing an equivalent series of tests on communications lines having known distances and known conditions or artifacts, i.e. sample lines where the presence of bridged taps, etc. is already known. This reference set is used to correlate to the actual test results from the communications line under test. Other manufacturers and methods of line qualification have no need for such a reference set of data since those manufacturers have access to field installation data showing the installation or placement of the various bridged taps, DLC's etc. This field installation data is typically (although in many instance not always reliably) maintained and updated by the telecommunications company as, for example, new bridged taps and new line concentrators are installed out in the field.

Some traditional methods of line qualification use a process whereby a user's modem and a remote modem are allowed to connect and a series of standard tests performed during the handshaking routine to ensure an adequate signal level versus frequency curve between the modems. However, information as to DLC's etc. is garnished separately by referring to the field installation data showing the placement of these items along the lines. The information from the signal level versus frequency curve test is then used in conjunction with information from the field data to qualify the line. However, there is little or no ability to test the line for the presence of heretofore undocumented DLC's or other line conditions or artifacts. If the line fails to achieve a valid frequency versus signal level, and if the field data is not up to date, then the service provider has no idea what is causing the line to fail it's test. This is a particular problem as the field installation data is often not maintained for accuracy, or may simply not be provided to another party or service provider to allow them to perform their own testing. As such, traditional methods cannot be used by the vast majority of service providers.

The present invention is designed to be flexible enough to work with all communications lines, including those that include undocumented artifacts, and can be used by any service provider without the need for access to a field installation database. Because the line testing is correlated to a reference set of data having a wide variety of potential conditions or artifacts, the presence of one or more of these conditions or artifacts can be deduced by comparing or correlating the test results with the reference set. The invention also uses a measure of the line's electrical distance, determined by multiplying the slope from a signal to frequency curve test by a constant value, to assist in the deduction process. Comparing the electrical distance to the geographic distance (as determined by any of a variety of methods including geocoding engines etc.) allows a variety of other conditions and artifacts to be deduced, and provides a reliable indicator to the service provider and to the end user, of the line's ability to support a particular type or class of service. Extensive field-testing has shown this technique to be between 95% and 98% accurate.

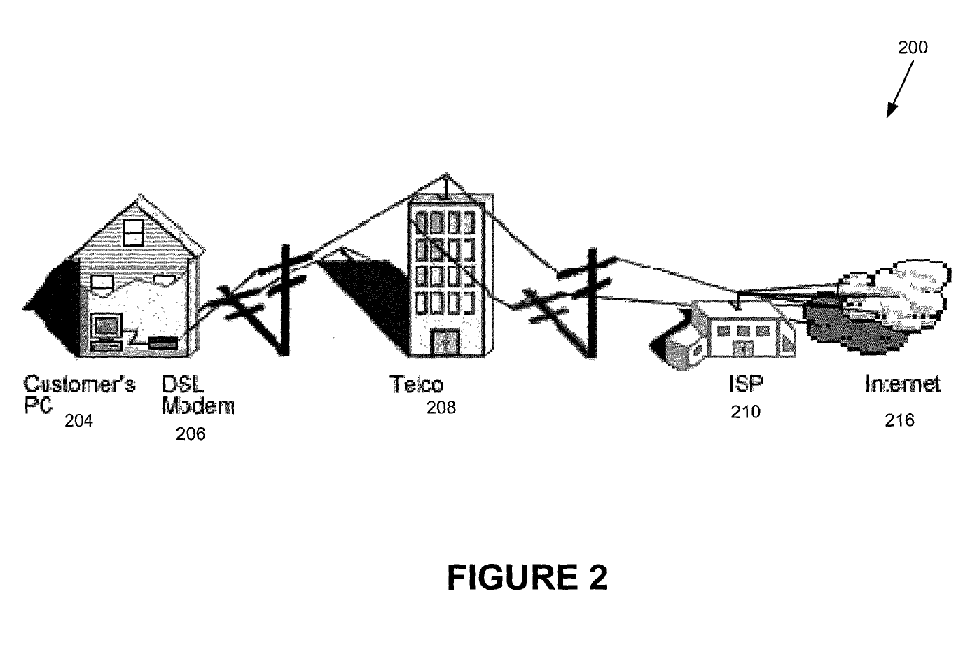

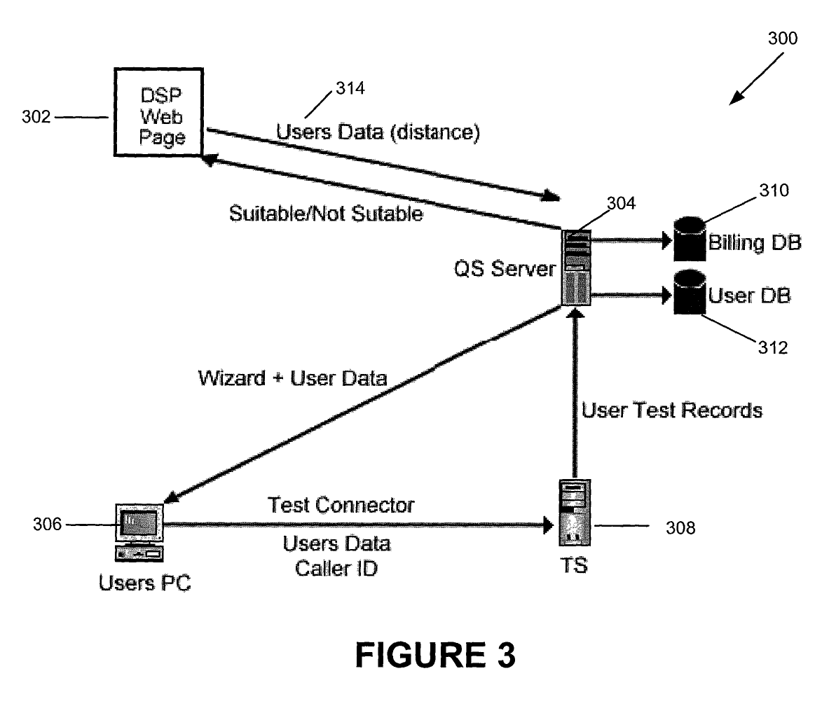

FIG. 3 illustrates DSL distance and electrical qualification apparatus 300, constructed according to an exemplary embodiment of the present invention, for determining whether a telephone line qualifies for DSL communications. The apparatus 300 of FIG. 3 is described with reference to FIG. 2 and includes a plurality of processing entities that serve various purposes in the qualification process. These processing entities include a DSL service provider (“DSP”) operating on a server and coupled to the Internet 216, a qualifier server (“QS”) 304 coupled to Internet 216, a user's PC 306 located at the user's home and coupled to local telephone line 212 via an internal modem, and a test server (“TS”) 308 coupled to CO 208. A web page 302 is provided on the DSP such that a PC user may access the page over Internet 216. The QS 304, in turn, communicates with a billing database 310 and a user database 312, both described in greater detail below. The user's PC 306 communicates with QS 304 over any suitable connection, such as dialing into ISP 210 through CO 208 of FIG. 2.

In FIG. 3, apparatus 300 further includes test equipment 316 coupled to the TS 308. Test equipment 316 is coupled through TS 308 to a telephone company CO, such as CO 208 of FIG. 2, via an ISDN circuit provided by the telephone company. In one example, test equipment 316 includes the TSI-1575 Modem/Network Test Unit made by Telesync® Inc. (www.telesync.com). The TSI-1575 is coupled to a CO switch via an ISDN interface. The user may dial into the TSI-1575 through the CO switch.

In FIG. 3, after user's PC 306 connects to test equipment 316 through the CO, various tests are performed by test equipment 316 using handshaking signals communicated from user's PC 306 modem to test equipment 316. Test equipment 316 measures line characteristics of these handshaking signals according to an international convention governing modem communications. These line characteristics include signal level, noise, and other properties. After test equipment 316 measures these characteristics, the results are provided to TS 308. The measurements are then delivered from TS 308 to QS 304 where electrical qualification tests are performed, as described in greater detail below.

In FIG. 3, TS 308 and QS 304 are shown as separate entities, for purposes of illustration. In other exemplary embodiments, TS 308 and QS 304 are combined into one server which performs the functions of both, as will be recognized by those skilled in the art.

Data Flow

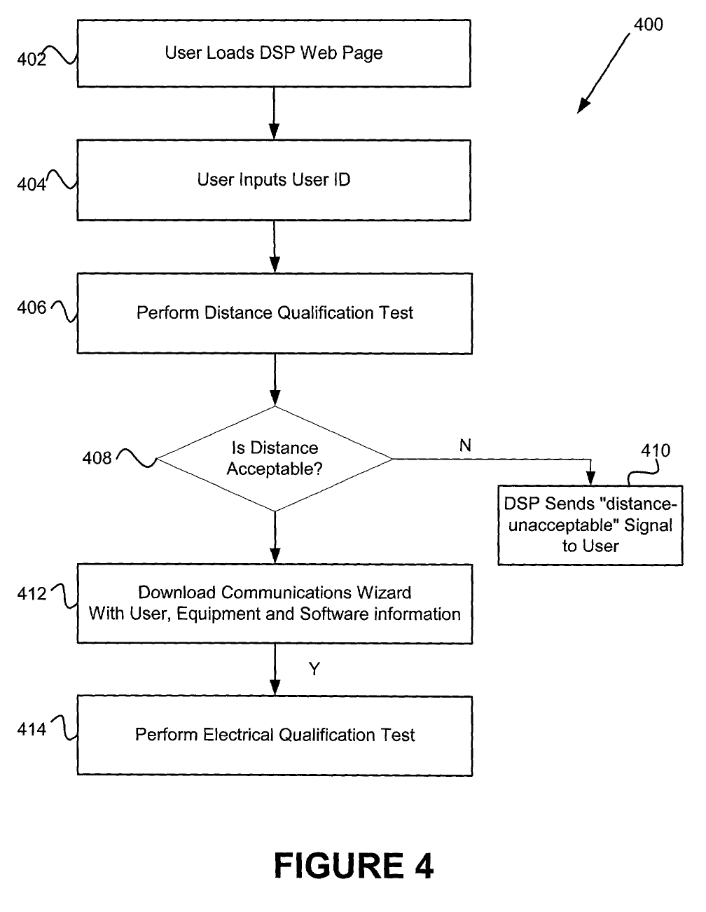

FIG. 4 illustrates exemplary data flow 400 for determining distance and electrical qualification of a telephone line for DSL communications. The data flow 400 of FIG. 4 is described with reference to FIG. 3. Initially, the user connects to the DSP via the Internet. In step 402, the user loads the DSP web page 302 on the user's PC 306. In step 404, the user then inputs some user ID data 314. This data 314 includes the user's name, address, phone number, and e-mail address. The user ID data is preferably entered into a web page form on the user's PC 306 and then transmitted to QS 304 via the Internet.

Distance Qualification

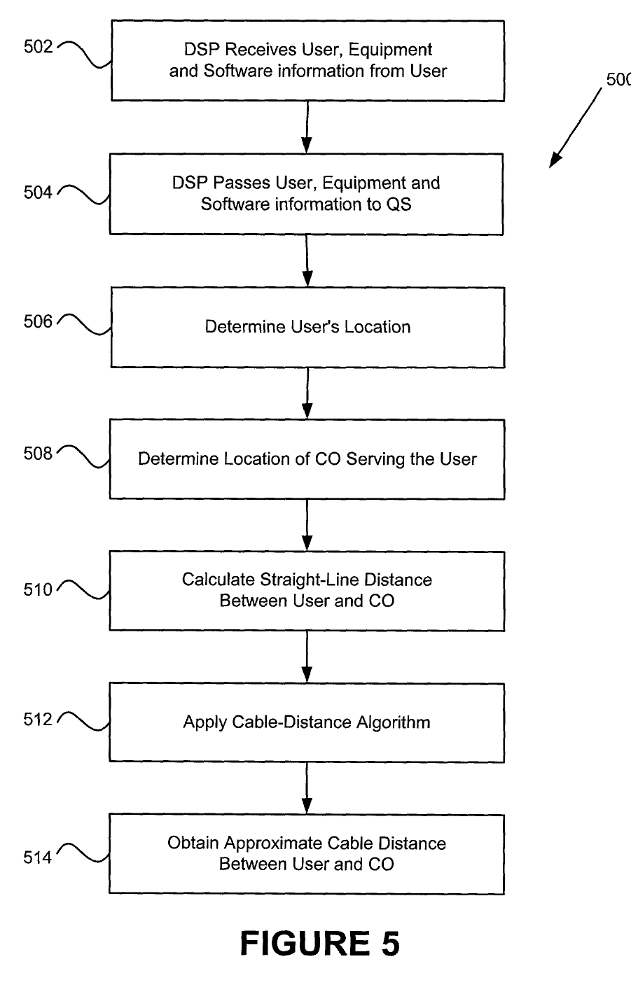

In FIG. 4, step 406 includes performing an exemplary distance qualification test for DSL communications, shown more specifically as method 500 in FIG. 5. In one exemplary embodiment, distance qualification method 500 is performed by the DSP using a geocoding engine. In another exemplary embodiment, the distance qualification test is performed by QS 304. The distance qualification test includes the use of a mapping program and list of addresses stored in user database 312. In step 502, the DSP receives the user ID information input by the user in step 404 of FIG. 4. In step 504, the DSP passes the user ID information to QS 304. Step 506 includes determining the location of user's PC 306. This is accomplished by indexing the user database 312 with the particular address input by the user in step 404. The user database 312 then returns the approximate coordinates of the user in the form of a longitude and latitude. If the user address does not match those stored in the address database then the user is asked by the software program to select an address from a choice of near matches to the one entered by the user. That is, if the user neglected to include AVENUE/STREET etc, this would cause the address matching program to ask the user to make a selection of an address with the appropriate information.

In FIG. 5, step 508 involves determining the location of the CO serving the user's PC 306. These coordinates are found using the user's phone number, input in step 404 as part of the user ID information. The area code and prefix of the user's telephone number are used to index the telephone company database 310, in which a list of telephone company central office numbers is stored, to ascertain the particular CO 208 serving the user. The longitude and latitude of the telephone company CO are returned by database 310. In step 510, the straight-line distance between the user's location and the location of the CO is then calculated.

In step 512 of FIG. 5, an algorithm is applied to the straight-line distance to approximate the actual length of telephone cable extending between the user and the telephone company CO. The algorithm simulates the path between the user's location and the telephone company CO using a cable route approximation between the user's home and the telephone company CO. This technique is based upon empirical information, similar to methods used by finding the shortest distance of travel between two geographical points. Currently the results of the Geo Distance are used and if it is 4,000 ft or less the value is increased by 15%. If it is over 4,000 ft, 600 ft is added and for the part that is over 4,000 ft we increase that portion by 28.5%. After applying the above factors, a length value is returned by the distance algorithm as the approximate cable route distance between the user and the CO, in step 514.

Most conventional distance qualification methods provide distance approximations that are simply too conservative or liberal. This is problematic because over-conservative estimates cause the telephone companies to turn away customers who could actually be serviced. Under-conservative estimates cause the telephone companies to proceed with installing DSL hardware only to later discover that the customer is too far away. The distance qualification method of FIG. 5 overcomes the problems associated with these conventional methods because a more accurate approximation of the cable-distance is provided. In FIG. 4, step 408 involves determining whether the approximate cable-distance is acceptable. Specifically, the approximate cable distance, computed as described above, is compared with a predetermined threshold. In step 410, if the approximate cable-distance exceeds this threshold, the DSP sends a “distance_unacceptable” signal to user's PC 306. This signal may be communicated to the user via web page 302 as displayed on user's PC 306. In step 412, if the distance qualification test in step 406 is acceptable, then a software program (hereafter, “Communications Wizard” or “Wizard”) and the user ID data previously input by the user are downloaded from the DSP to user's PC 306. When executed, the Communications Wizard causes user's PC 306 to connect to test equipment 316. The test equipment 316 then performs the electrical qualification test, step 414, described in greater detail below. That threshold is determined by the customer, usually 18,000 ft.

Electrical Qualification

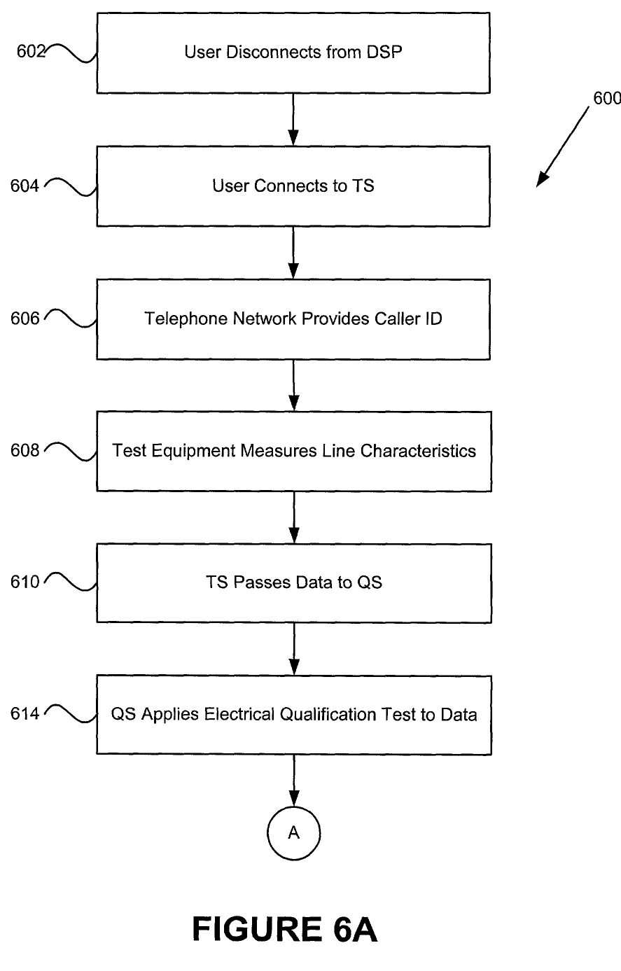

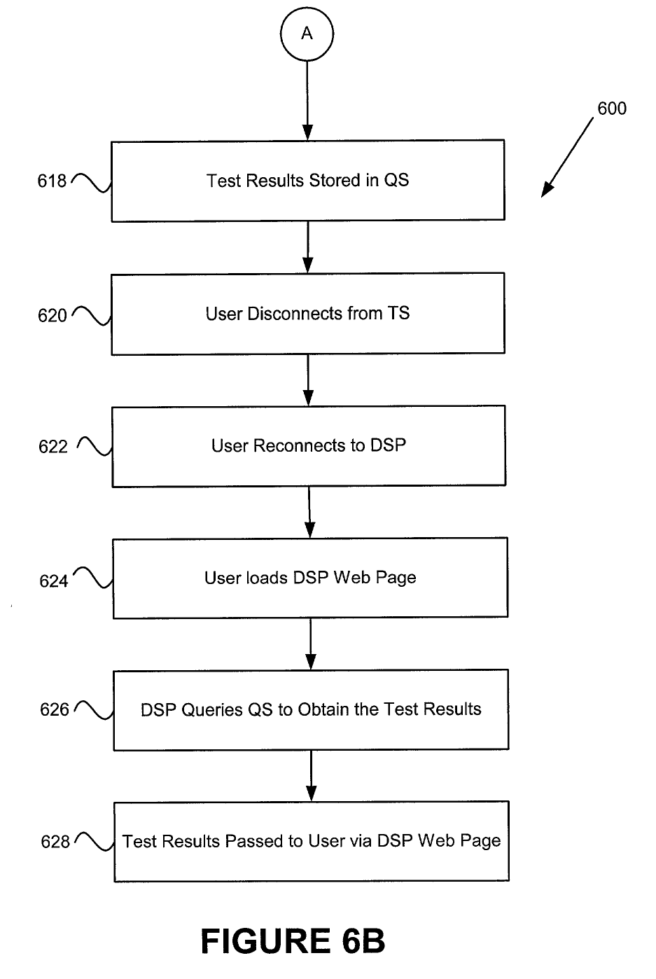

FIGS. 6a and 6b illustrate an exemplary method 600 of determining electrical qualification of a telephone line for DSL communications, according to an exemplary embodiment of the present invention. In FIG. 6a, upon executing the Wizard on the user's PC 306, in step 602, the modem in PC 306 disconnects from the DSP web page so the modem is available to dial into test equipment 316. In step 604, the user's PC 306 modem connects to test equipment 316 connected to TS 308, using a telephone number embedded with the Wizard when it is downloaded to user's PC 306. This connection is made through the CO, and a communications path is then established between PC 306 and test equipment 316. In alternative embodiments, user's PC 306 dials and connects to test equipment 316 directly. In step 606, the Wizard then causes the user's PC 306 to transmit the caller_ID information to TS 308 via the test equipment 316. The caller_ID information is captured by the test and is provided by the telephone network. It is sometimes referred to as caller ID.

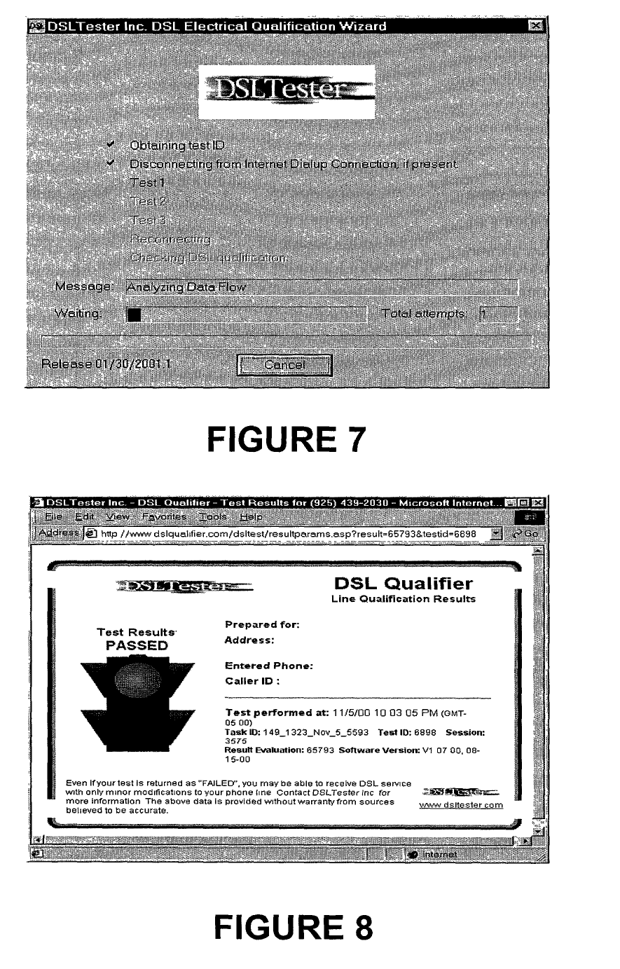

In step 608 of FIG. 6a, the testing equipment 316 conducts various tests with user's PC 306. Test equipment 316 measures various characteristics of signals transmitted over the communications path from user's PC 306 to test equipment 316, including transaction speed, signal level, noise, and other properties. After test equipment 316 measures these characteristics, the resulting data is provided to TS 308 and coordinated with the user ID information provided by the particular user. In step 610, the measurements and associated user ID and called_ID information are then delivered by TS 308 immediately to QS 304. In step 614, electrical qualification tests for DSL communications are then performed by QS 304 on the data, including general purpose testing, as well as individualized testing for load coils, bridge taps, and DLC's/SLC's. These qualification tests are described in greater detail below. The Wizard causes the electrical qualification tests to be performed three times. Multiple tests are used to ensure the reliability of the results. During the electrical qualification testing, a screen with status information is displayed on user's PC 306, as shown in FIG. 7.

In step 618 of FIG. 6b, the results of the DSL electrical qualification processing are saved on QS 304 for later retrieval by the DSP. In step 620, the Wizard disconnects the modem in user's PC 306 from TS 308 and, in step 622, reconnects the user's PC to the DSP requiring some user intervention. In step 624, DSP web page 302 is again loaded onto user's PC 306. In step 626, the DSP queries the QS 304 to obtain the test results and the results from the DSL electrical qualification determination. In step 628, these results are then reported to the user via the DSP web page 302.

In FIG. 8, if the electrical qualification test results are positive, a “Congratulations!” message or the like could be transmitted from the DSP to user's PC 306 and displayed on the PC 306 monitor. The DSP web page 302 acts upon the results by offering the user online ordering options and other information such as pricing, etc.

The Electrical Qualification Tests

Various tests are performed as part of the electrical qualification determination. Certain line characteristics, as measured by test equipment 316, are considered for each of the tests. Generally, weights are applied to the measurements, and the resulting values are then added to define a measured value. This measured value is then compared with a predetermined threshold value. If the measured value exceeds the threshold value, DSL communications are not supported by the existing telephone line. Consequently, a “fail” condition arises, and this condition is communicated to the user. Alternatively, if the measured value does not exceed the threshold value, DSL communications are supported and a message such as that shown in FIG. 8 is conveyed to the user.

The various weights and threshold value are set based on empirical data derived from tests conducted on telephone lines, in laboratory tests and based upon engineering data. The weights are adjusted as needed, as will be recognized by those skilled in the art. The weights are preferably set such that if one or more of the particular measurements are unsatisfactory, a “fail” condition arises.

General Purpose Testing—Test for Load Coils, Bridge Taps and SLC/DLC

Several tests are conducted to check the telephone line for the presence of impediments. These tests consist of correlating the frequency vs. attenuation curve of the tested analog circuit to the frequency attenuation curves obtained from controlled experimentation and engineering models of lines. When test equipment 316 conducts its measurements, a signal is sent from the user's PC 306 modem to test equipment 316. This signal generally includes frequencies ranging between a lower value and an upper value. In one exemplary embodiment, this range is between about 0 and 4 kHz, although other frequencies may be used as will be understood by the skilled artisan. The signal sweeps from the lower value to the upper value of the frequency range, and signal levels are measured at discrete frequency values in the range by test equipment 316. The data points of signal level at given frequencies serve to approximate a frequency-level curve which characterizes the tested line. These data points are normalized to account for anomalies in the test equipment and for any amplification provided by the telephone service. The normalization parameters have been developed by experimentation in controlled situations and by engineering modeling of how the loop of a specific length should behave. Normalization is what is done to take any abnormalities that the test equipment has out of the results.

Also the slope of the frequency vs. signal level curve is calculated between discrete frequency values in the range of about 450 Hz to 3000 Hz. The slope is multiplied by a constant to yield the electrical distance.

The signal to noise ratio (SNR) must be above a specific threshold otherwise the line is immediately disqualified. If the SNR is marginally above the minimum threshold and the electronic distance exceeds the distance calculated as described above (a.k.a. geographic distance) significantly, then the line is deemed to have marginal DSL qualities. These settings are currently −30 db, with the minimum −30 to −35 db.

The next test performed is the correlation of the measured Attenuation versus Frequency curve to a reference Attenuation versus Frequency curve for a loop of the same length as the Local Loop under test. The engineered reference curves are derived for lines with no load coils. If the correlation is less then a given threshold then there is a possibility of the presence of load coils. Correlation is then made to reference curves of lines with known load coils that are properly placed, (i.e. properly loaded lines) and with improperly loaded lines, to determine if load coils are present or other impediments such as DLC or bridge taps. In the case where the curves correlates to properly loaded line curves, other factors such as distance and further correlation test to curves corresponding to calculated distance described below are used in determining whether DLC or bridge taps are indicated. All the references to curve refer to the same term.

The next test consists of comparing the calculated distance described above with the geo distance. This test is valid only if the first test indicated no load coils. If the distances differ significantly then either a bridge tap or a DLC is indicated depending on whether the calculated distance is greater than or less than the geographic distance.

The next test examines if there is a sharp drop off (25 db or greater) in the signal level at the high end of the frequency scale. If the drop is greater then a predetermined amount (in decibels) then a DLC is indicated.

Another test determines a condition where the system cannot initially make a pass/fail judgment, giving rise to a situation referred to as a marginal result, because there may be doubt as to whether the line will work. To tackle this situation the system can be designed to look at some of the data and determine if the signal-to-noise ratio is below a certain level. If the difference in the calculated and measured distance is greater than a particular amount the result is labeled as marginal. The values used here are between 30 and 35 db.

Another test involves looking at the signal-to-noise ratio and if it is below a minimum requirement, then the test (i.e. the line) is failed. The value here is less than 30 db and the test is failed.

DSL Test Algorithm

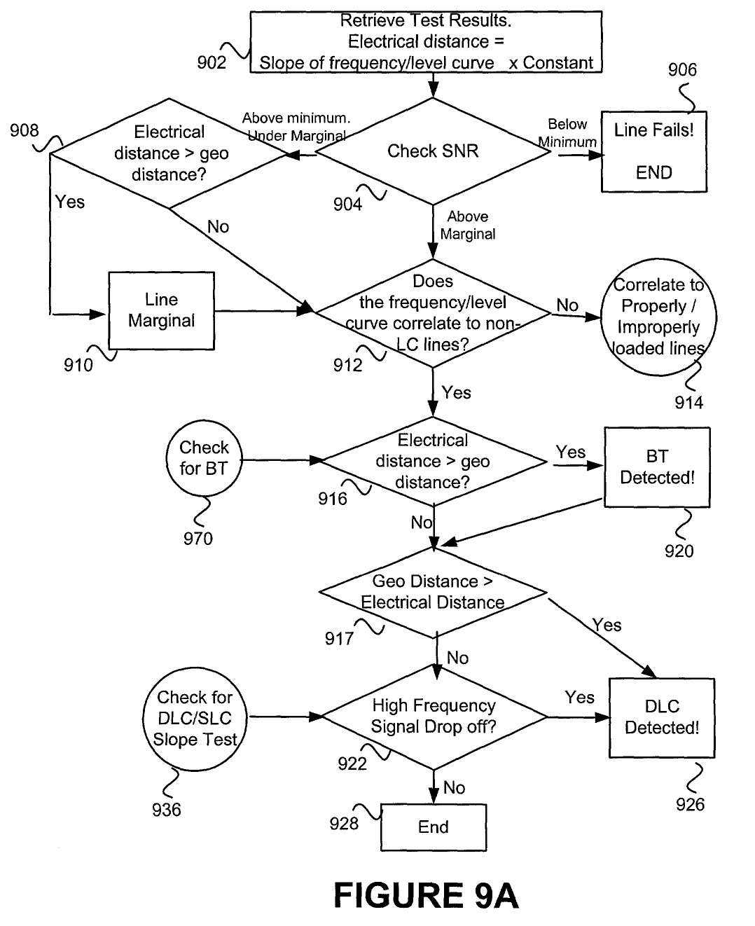

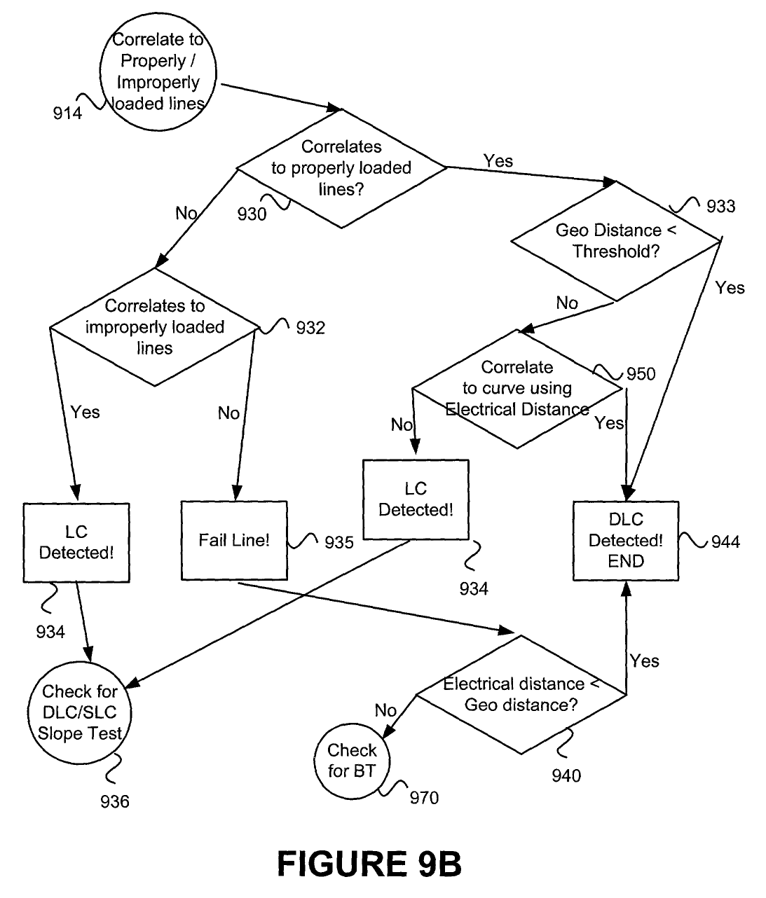

FIGS. 9A and 9B illustrate an exemplary DSL test algorithm in accordance with an embodiment of the invention. As shown in FIG. 9A, the process begins by retrieving the test results, in step 902, and calculating the calculated distance of the communications line by multiplying the slope of the frequency to level curve by a constant value, “C”. In this case the value of C is 5787781.3. This constant value C is determined experimentally by measuring the slope of the frequency to level curve in communications lines having known (or exact) lengths and other properties. The constant can then be used to assist in calculating the calculated distance for communications lines having unknown lengths or properties. In step 904, the signal to noise ratio (SNR) is then calculated. If the SNR ratio is found to be below a minimum predetermined value (minimum is less than 30 db and the marginal range is 30 to 35 db) then, in step 906, the system determines that the line has failed the test, i.e. it is not able to support the required class or type of service, (for example DSL service). If the SNR is between 30 and 35 db and the BT distance is greater than 5,000 feet it is marginal. If the check SNR test determines that the signal to noise ratio is above a minimum predetermined value but below a marginal value, then the calculated distance is measured to determine whether it is greater than the sum of the geographic distance between the telephone subscriber and the telephone company serving office, in some embodiments together with an added value or threshold value, in step 908. The threshold value can be either predetermined on a global level, or can be individually determined in cooperation with a DSP or service provider, or whomever else is running the testing procedure, to suit their particular needs. It is primarily used to compensate for potential inaccuracies caused if the process relied just on the geocode distance, which in some instances is prone to inaccuracy. The threshold value can be used to add another arbitrary amount of distance, e.g. 1000 ft, or 5000 ft, that acts as a buffer to ensure that the final calculated distance is a reliable indication of the true distance, with some room for error. If the line is determined to be marginal then, in step 910 this finding can be reported to the user or system operator. If however, in step 904 the check signal to noise ratio test determines that the line is above-marginal, or if the calculated distance is less than the geographic distance/value sum, then the process testing algorithm proceeds to check whether the frequency level curve correlates to any non-LC lines, in step 912. If the curve does not correlate to non-LC lines, then in step 914 the system correlates the curve to properly or improperly loaded lines (the sequence of steps flowing from step 914 is described in further detail below with reference to FIG. 9B). If, in step 912, the frequency level curve is found to correlate to non-LC lines, then the process continues to calculate whether the calculated distance is greater than the geographic distance, in step 916. It does this to check for bridged taps (BTs), which if it detects are present, are then reported in step 920. In step 917 a check is made to determine if the Geo distance is greater than the calculated distance. If it is, then a DLC is indicated in step 926, and the process ends If the Geo distance is not greater than the calculated distance, then a check for high frequency signal drop-off is run, in step 922. This test is used as part of a DLC/SLC slope test, in step 922, which if found to be true is used to determine that a DLC has been detected, in step 926. The process then ends, at step 928.

FIG. 9B illustrates in further detail the sequence of steps flowing from step 914, in which the frequency level curve that is found to not correlate to non-LC lines is then correlated to properly or improperly loaded lines. In step 930, the process checks whether the frequency level curve for the communications line being tested correlates to properly loaded lines. If it determines that it does not correlate to properly loaded lines, then in step 932 it checks the frequency level curve to improperly loaded lines. If it makes the determination that it does correlate to improperly loaded lines then it determines that an LC has been detected, in step 934. The process then, in some embodiments, continues to check for DLC/SLCs using a slope test, in step 936. Otherwise, if in step 932 it determines the frequency level curve does not correlate to improperly loaded lines, then the system reports a failed line in step 935, and continues to step 940, described in further detail below.

If however in step 930, the process determines that the line being tested correlates to a properly loaded line, then in step 933 it is determined if the Geo distance is less than a threshold value, for example 7,000 ft. If the Geo distance is less than this value, then a DLC is indicated, in step 944. If the Geo distance is not less than the threshold value then, in step 950, the frequency level curve for the line being tested is correlated to the curve using the electrical distance. If the answer is “Yes” and it correlates, then the system determines that a DLC has been detected on the line, in step 944. If the answer is “No”, then the system indicates the presence of an LC, and proceeds to further check if there might be a DLC involved by using the DLC slope test in 936. In step 940 the electrical distance calculated is compared to the Geo distance. If the electrical distance is found to be less than the Geo distance, then the system determines that a DLC has been detected, in step 944, and the process ends. If the electrical distance is not less than the Geo distance then a BT check is performed, in step 970, which examines for BTs.

Typical Implementation

In accordance with one exemplary embodiment of the invention, the following settings, tests and logic can be implemented in the DSL evaluation testing software for line testing purposes. It will be evident to one skilled in the art that different frequency ranges, signal-to-noise limits, curve correlation coefficients, threshold distance values, and other test parameters, can be used within the spirit and scope of the invention, and that the invention is not limited to the particular implementation described below for purposes of illustration. These curve sets are for non-loaded line, properly loaded line and improperly loaded line of the similar distance to the line being tested.

1. All correlation tests are done in the 450-3600 Hz range. If correlation to Curve 1 is less than 0.98 and correlation to Curve set 2 is less than 0.97 and correlation to curve set 3 is greater than 0.97 then an LC is definite.

2. If the signal-to-noise ratio is below 30 db the test fails.

3. If correlation to curve 1 greater or equal to 0.98 then no LC.

4. If correlation to curve 1<0.98 and correlation to curve set 2 is greater than 0.97 then there is either an LC or a DLC to be determined with additional tests below.

a. If the distance is less than 7000 ft assume DLC.

b. Otherwise correlate to curve 4 (a curve of the distance for the electrical length), which is derived in the same way curve 1 was derived except that the electrical distance is used instead of the geo distance. Correlation>=0.95 indicates a DLC. Correlation<0.95 indicates an LC.

5. If correlation to curve 1>=0.98 or correlation to curve sets 2 and 3 are less than 0.97 then test for the following:

a. If Electrical Distance>Geo Distance by 5000 feet (parameter is set via XML (XML is the code used to transfer information over the Internet between web pages)) then BT.

b. If correlation to curve 1<0.98 and Electrical Distance>Geo Distance by 10000 feet then BT.

6. The DLC/SLC Slope Test—If the level drops 25 db or more from the frequencies of 3300 hz to the frequency of 3750 hz then a DLC is indicated.

7. If the signal-to-noise is between 32 db and 35 db and there is a bridged tap of greater than 5,000 feet than the test is inconclusive and it is reported as Marginal. The “signal-to-noise” ratio is the “signal-to-noise ratio measured on the communications line.”

An alternate implementation differs from the above in that:

1. Test 6 is done unconditionally; and,

2. Test 5b is done only if an LC has been determined.

Electrical distance is calculated as follows: Calculate the slope of the frequency/attenuation curve between 450 Hz to 3,000 Hz. The result is multiplied by a constant C to get the distance.

Advantages

The distance and electrical qualification techniques provided in accordance with exemplary embodiments of the present invention are advantageous because they save time and money for both telephone companies and customers. Ordinarily, it costs a telephone company hundreds of dollars to send a representative to the customer's house to try to ascertain whether DSL is supported. Hundreds of dollars may then be spent installing the necessary DSL hardware, only to later discover that a load coil, long bridged tap, or SLC/DLC coupled along the line was not detected. The customer is expecting a successful DSL installation during this time, but then is told that DSL cannot be installed after all. Distance and electrical qualification apparatus and methods in accordance with exemplary embodiments of the present invention overcome these problems. The telephone companies are spared the cost of investigation and installation, and the customer will know immediately whether DSL is supported.

Storage, Transmission and Execution of the Wizard

After the user downloads the Communications Wizard from the DSP, the Wizard is stored on user's PC 306, which is any conventional computer system. User's PC 306 includes various hardware components, including a processor such as a central processing unit (CPU), a memory such as a RAM, and a non-volatile storage medium, all in communication with one another. Other hardware components include disk drives, network devices, and other suitable devices known to those skilled in the art.

In one exemplary embodiment, the processor contains a single microprocessor. In another exemplary embodiment, a plurality of microprocessors are provided for configuring user's PC 306 as a multiprocessor system.

In one exemplary embodiment, the memory includes banks of dynamic random access memory (DRAM) and high speed cache memory. The memory stores, in part, instructions and data for execution by the processor. This includes the executable code of the Wizard when executed.

The user's PC includes a mass storage device, peripheral devices, input devices, portable storage medium drives, a graphics subsystem and a display. These components are connected via a single bus or multiple data transport means. In one exemplary embodiment, the processor and memory are connected via a local microprocessor bus, and the mass storage device, peripheral devices, portable storage medium drives, and graphics subsystem are connected via one or more input/output (I/O) buses.

The mass storage device, which is typically embodied as a magnetic disk drive or an optical disk drive, is a nonvolatile storage device for storing data and instructions for use by the processor. In one exemplary embodiment, mass storage device 335 stores the Wizard which, when executed, is loaded into memory. In another exemplary embodiment, the Wizard is stored in the processor.

The portable storage medium drive operates in conjunction with a portable nonvolatile storage medium, such as a floppy disk, hard disk, or CD-ROM, and may include one or more machine-readable media including semiconductor memories (e.g., EEPROM), or other computer-readable medium, to input and output data and code to and from the user's PC. In one exemplary embodiment, the Wizard is stored on the portable medium and is input to the user's PC via the portable storage medium drive.

The peripheral devices used with user's PC include various computer support devices, including I/O interfaces, to add additional functionality to the user's PC. Other exemplary peripheral devices include a network interface card for interfacing the user's PC with a network, a modem, and the like.

Input devices provide a portion of the user interface. Such input devices include an alpha-numeric keypad for inputting alpha-numeric and other key information, and a pointing device such as a mouse, trackball, stylus, and cursor direction keys. Such devices provide additional means for interfacing with the Wizard, in accordance with exemplary embodiments of the present invention.

The user's PC includes a graphics subsystem and display for displaying textual and graphical information. The display includes a cathode ray tube (CRT) display, liquid crystal display (LCD), other suitable display device. The graphics subsystem receives textual and graphical information and processes the information for output to the display. The display is used to display objects, component interfaces and other information that is part of the user interface.

The user's PC also includes an audio system. In one exemplary embodiment, this audio system includes a sound card that receives audio signals from a microphone used as one of the peripheral devices. The user's PC also includes output devices. Examples of suitable output devices include speakers, printers, and the like.

The devices contained in the user's PC, as described above, are those typically found in general purpose computer systems, and are intended to represent a broad category of such computer components that are well known in the art. The above description represents several platforms, which can be used for storing, transmitting and executing the Communications. Numerous other platforms also suffice, including Macintosh-based platforms available from Apple Computer, Inc., platforms with different bus configurations, networked platforms, multi-processor platforms, other personal computers, workstations, mainframes, and navigation systems.

In another exemplary embodiment, the Wizard is executed using a specialized digital computer or microprocessor programmed according to the teachings above. Appropriate software coding can readily be prepared by skilled programmers based on the teaching above.

In still further exemplary embodiments, the Wizard is implemented by the preparation of the application specific integrated circuits or by interconnecting an appropriate network of conventional component circuits, as will be readily apparent to those skilled in the art.

User's PC 306 further includes software programs which are stored on and executed using the several hardware components. This software includes an operating system stored in memory, and the Wizard which resides in the storage medium.

When the computer is on and the Wizard is executed, the Wizard is loaded into memory. In other embodiments, the Wizard is stored in various locations in user's PC 306, as will be understood by those skilled in the art. The Wizard and the operating system interact with one another to provide data access and control of the PC 306 to the user. The user of computer system 100 executes the Wizard by instructing the operating system to do so. The operating system then executes the Wizard and, in some examples, other programs which interact with the Wizard. This is done using the computer memory, the processor, and other devices within and available to the computer as needed.

The operating system in user's PC 306 is any conventional operating system known to those skilled in the art. Popular conventional operating systems used in personal computers include 32-bit Windows (“Win32”) operating systems such as those made by Microsoft Corp. These include Microsoft Windows NT, Windows 95, Windows 98 and Windows 2000. Other operating systems which are used in accordance with exemplary embodiments of the present invention include UNIX and DOS.

In another exemplary embodiment, the Wizard is part of a computer program product which is a storage medium or media having instructions stored thereon which are used to program a computer to perform the qualification techniques described above. Suitable storage media include, but are not limited to, any type of disk including floppy disks, optical disks, DVD, CD ROMs, magnetic optical disks, RAMs, EPROM, EEPROM, magnetic or optical cards, and other media.

Stored on any one of the computer readable media, the Wizard includes software for controlling both the hardware of the general purpose/specialized computer or microprocessor, and for enabling the computer or microprocessor to interact with a human user or other mechanism utilizing the results of exemplary embodiments of the present invention. Such software includes, but is not limited to, device drivers, operating systems and user applications. Preferably, such computer readable media further include software for performing the techniques described above.

The Wizard is, in some exemplary embodiments, located on any of various storage means in the user's PC. In other exemplary embodiments, the Wizard is located on an electronic signal transferred over a data network, such as the Internet, a frame relay network, an ATM (Asynchronous Transfer Mode), or a local area network that transfers the electronic signal over such network. In still further exemplary embodiments, the qualification methods described above are performed over the data network. Those skilled in the art will recognize merely transferring the Wizard over a network, rather than executing the Wizard as part of a computer system, does not avoid the scope of the present invention.

Testing from a Central Location

Although the description of the test process described above focuses upon the testing being initiated from the end users site, this does not preclude the testing being initiated from a central site to end users. In order to accomplish this mode of testing, in some embodiments of the invention the end user's modem can be set for auto answer and software installed at the end user to provide the cooperation between the modem and the centrally-located test system, so that the testing can be initiated from the central site. Throughout the specification Geo distance and geographical distance are the same. Also electrical and electric distance are the same.

The foregoing description of the present invention has been provided for the purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A system for allowing a communications service provider to test the ability of a communications line to support a particular type or class of communications service, comprising:
a test server, for providing a connection over a communications line between a user's equipment and the system;
a test equipment, coupled with the test server, for performing tests to determine the characteristics of the communications line, wherein the tests include comparing the characteristics of the line being tested with previously collected data describing the characteristics of communications lines having known properties such as distance, conditions or artifacts thereon; and,
a reporting device, for reporting the results of the tests.

2. The system of claim 1 further comprising:
a service provider server, for allowing a user to interact with the system and to initiate the tests.

3. The system of claim 2 wherein the service provider server displays a Web page for allowing a user to interact with the system.

4. The system of claim 3 wherein the reporting device is a Web page used to display the results of the tests.

5. The system of claim 1 wherein the tests are used to measure any or all of signal level, noise, or other characteristics of the communications line, to determine the presence of bridged taps, load coils, or subscriber line concentrators between the user's equipment and the test server.

6. The system of claim 5 wherein the user's equipment includes a modem at the remote location, and wherein the tests are performed as part of a handshaking process between the test equipment and the modem.

7. The system of claim 2 further comprising
a distance qualifier, for determining a measure of the distance between the user and a central telephone or communications office.

8. The system of claim 7 wherein the distance qualifier is a geocoding engine on the service providers server for determining the measure of distance.

9. The system of claim 7 wherein the distance qualifier is a qualification server in communication with the test server for determining the measure of distance.

10. The system of claim 3 wherein the user can initiate the testing by downloading a software program from the Web page.

11. The system of claim 1 further comprising a user identifier associated with the user, or with the user's equipment, or both, and with which user identifier the results of the tests are associated.

12. The system of claim 11 wherein the user identifier is used to determine additional information about the user, including the distance of the user from a central telephone or communications office.

13. The system of claim 1 wherein the communications line is a telephone line and the type or class of service is a digital subscriber line service.

14. The system of claim 11 wherein the user identifier is any or all of a user identifier, caller identifier, system identifier or software identifier.

15. The system of claim 5 wherein said tests are used to compare the characteristics of the communications line being tested with previously collected data describing communications lines that include any of bridged taps, load coils, or subscriber line concentrators.

16. A system for testing a user's telephone line to assess the ability of the telephone line to support digital subscriber line service, comprising:
a Web server, including Web pages accessible thereon for allowing a user to interact with the system, and for reporting the results of tests;
a software program, that can be retrieved or downloaded and installed to a user's computer system or equipment;
a test server, for allowing the installed software program to initiate a connection, via the telephone line to be tested, from the user's computer system or equipment to a test equipment; and,
a test equipment, coupled with the test server, for performing tests on the telephone line to determine the ability of the line to support digital subscriber line service, wherein the tests include comparing the characteristics of the line being tested with previously collected data describing the characteristics of communications lines having known properties such as distance, conditions or artifacts thereon.

17. A method for testing a user's communications line to assess the ability of the communication line to support a particular type or class of communications service, comprising the steps of:
providing a Web page at which a user can retrieve or download a software program to the user's computer system or other equipment;
allowing the software program to connect the user's equipment to a test server via the communications line to be tested;
testing, using a test equipment, the signal level, noise or other properties of the communications line, wherein said step of testing includes comparing the characteristics of the line being tested with previously collected data describing the characteristics of communications lines having known properties such as distance, conditions, or artifacts thereon;
assessing the ability of the line to support the particular type or class of communications service; and,
reporting the results of the testing to the user.

18. The method of claim 17 wherein the step of testing includes
measuring any of signal levels, noise, or other characteristics of the communications line, to determine the presence of bridged taps, load coils, or subscriber line concentrators between the user and the test server.

19. The method of claim 17 wherein the user's equipment includes a modem at the remote location, and the tests are performed during a handshaking process between the test equipment and the modem.

20. The method of claim 17 further comprising
determining a measure of the distance between the user and a central office.

21. The method of claim 20 wherein said step of determining includes using a geocoding engine at the providers server for determining the measure of distance.

22. The method of claim 20 wherein said step of determining includes using a qualification server in communication with the test server for determining the measure of distance.

23. The method of claim 17 further comprising
receiving a user identifier from the user, or the user's equipment, or both, and associating the results of the tests with this user identifier.

24. The method of claim 17 further comprising using the user identifier to determine additional information about the user, including the distance of the user from a central office.

25. The method of claim 17 wherein the communications line is a telephone line and the type or class of service is a digital subscriber line service.

26. The method of claim 24 wherein the user identifier is any of a user identifier, caller identifier, system identifier or software identifier.

27. The method of claim 18 wherein said step of assessing includes comparing the characteristics of the communications line being tested with previously collected data describing communications lines that include any of bridged taps, load coils, or subscriber line concentrators.

28. A method for allowing a user to test the ability of their communication line to support a particular type or class of communication service, comprising the steps of:
allowing a user to access an Internet site or Web page to access or retrieve a software program;
installing the software program on the user's machine;
allowing the user's machine to be connected to a test server via a communications line;
executing a series of tests on the communications line to measure the signal level, noise or other properties of the communications line, and to assess the ability of the line to support the particular type or class of communications service, wherein the tests include comparing the characteristics of the line being tested with previously collected data describing the characteristics of communications lines having known properties such as distance, conditions or artifacts thereon.

29. The method of claim 28 further comprising the steps of:
associating an identifier with the user or with the user's system;
associating the test results with the user identifier; and,
notifying the user of the results of the testing.

30. The method of claim 28 wherein the step of allowing the user's machine to be connected to a test server via a communications line includes allowing the user's computer to contact the test server.

31. The method of claim 28 wherein the step of allowing the user's machine to be connected to a test server via a communications line includes allowing the test server to contact the user's computer.

32. The method of claim 28 wherein the communications line is a telephone line and the type or class of service is digital subscriber line service.

33. The method of claim 29 wherein the user identifier is any of a user identifier, caller identifier, system identifier or software identifier.

34. A method for allowing a user to test the ability of their communications line to support a particular type or class of communication service, comprising the steps of:
accessing a service provider Web page;
downloading a software program or other application code; and,
executing the program or code to perform a series of tests to measure the signal level, noise or other properties of the communications line, and to assess the ability of the communications line to support the particular type or class of communications service, wherein the tests include comparing the characteristics of the line being tested with previously collected data describing the characteristics of communications lines having known properties such as distance, conditions or artifacts thereon.

35. The method of claim 34 further comprising the step of
receiving notification of the test results.

36. The method of claim 34 wherein the communications line is a telephone line and the type or class of service is digital subscriber line service.

37. A processor-readable medium including instructions stored thereon which when read and executed cause the processor to perform the steps of:
providing a Web page at which a user can retrieve or download a software program to the user's computer system or other equipment;
allowing the software program to connect the user's equipment to a test server via the communications line to be tested;
testing, using a test equipment, the signal level, noise or other properties of the communications line, wherein said step of testing includes comparing the characteristics of the line being tested with previously collected data describing the characteristics of communications lines having known properties such as distance, conditions, or artifacts thereon;
assessing the ability of the line to support the particular type or class of communications service; and,
reporting the results of the testing to the user.

38. A method for determining the electrical distance of a user's communications line for use in qualifying the line to support a particular type or class of communications service, comprising the steps of:
connecting a user's equipment to the test server via the communications line to be tested;
using a test equipment to test or measure the characteristics of the communications line including comparing the characteristics of the line being tested with previously collected data describing the characteristics of communications lines having known properties such as distance, conditions, or artifacts thereon; and,
multiplying the value determined for that line by a factor to determine the electrical distance of the line.

39. The method of claim 38 wherein said step of using a test equipment includes measuring the frequency to signal level of the communications line.

40. The method of claim 38 wherein the electrical distance is compared to the geographic distance between the telephone service subscriber and the telephone company serving office.

41. The method of claim 40 wherein a significant difference in electrical and geographic distance is used to indicate the presence on the communications line of a bridge tap or a DLC.

42. The method of claim 38 further comprising, prior to said step of connecting, the step of:
downloading a software program to the user's computer system or other equipment, and allowing the software program to connect the user's equipment to the test server.
